(19) United States
(12) Patent Application Publication
(10) Pub. No.: US 2015/0193580 A1
(43) Pub. Date: Jul. 9, 2015

(54) ELECTRONIC MEDICAL RECORD SYSTEM WITH AUTOMATED HEALTH CARE SERVICES EVALUATION

(71) Applicant: MEDecision, Wayne, PA (US)

(72) Inventors: Charles F. Mosier, III, Rochester, MN (US); Chaminda Gunaratne, Phoenixville, PA (US); Matthew Heilman, West Chester, PA (US)

(73) Assignee: MEDecision, Wayne, PA (US)

(21) Appl. No.: 14/149,705

(22) Filed: Jan. 7, 2014

(51) Int. Cl. G06F 19/00

(52) U.S. Cl. CPC G06F 19/322

(57) ABSTRACT

A system for processing medical data comprising an order processing system operating on a first processor and configured to receive an order generated from within a patient profile of an electronic medical records system and to generate an order message. A health services system operating on a second processor and configured to receive the order message and to process the order message to identify an alternate identification field and one or more health services provider fields and to generate an insurance services provider request as a function of the alternate identification field and to transmit the insurance services provider request to an insurance services provider system. An insurance services interface system configured to receive a response message from the insurance services provider system and to transmit the response message to the order processing system.

### TECHNICAL FIELD

The present disclosure relates to electronic medical records systems, and more specifically to an electronic medical record system with automated health care services evaluation.

### BACKGROUND OF THE INVENTION

When a medical services provider wants to order medical services for a patient, they must ask staff to call or otherwise interface with the patient's insurance company to obtain prior approval for the medical services. This process is time consuming and complex, with much associated manual activity that adds to the cost and risk of error.

### SUMMARY OF THE INVENTION

A system for processing medical data is disclosed that includes an order processing system operating on a first processor that is configured to receive an order generated from within a patient profile of an electronic medical records system and to generate an order message. A health services system operating on a second processor is configured to receive the order message and to process the order message to identify an alternate patient identification field and one or more health services provider fields and to generate an insurance services provider request as a function of the alternate identification field and to transmit the insurance services provider request to an insurance services provider system. An insurance services interface system is configured to receive a response message from the insurance services provider system and to transmit the response message to the order processing system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for seeking approval for medical services from an electronic medical records system in accordance with an exemplary embodiment of the present disclosure; and

FIG. 2 is a diagram of an algorithm for seeking approval for medical services from an electronic medical records system in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

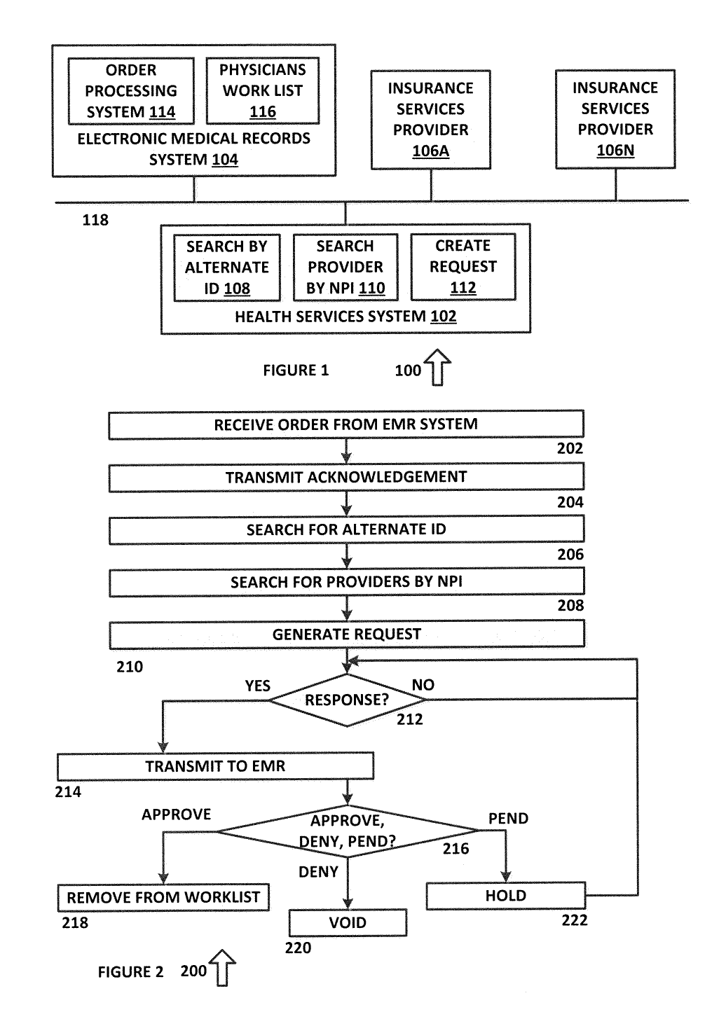

FIG. 1 is a diagram of a system 100 for seeking approval for medical services from an electronic medical records system in accordance with an exemplary embodiment of the present disclosure. System 100 includes health services system 102, electronic medical records system 104 and insurance services providers 106A through 106N, each of which can be implemented in hardware or a suitable combination of hardware and software, and which can be one or more software systems, each operating on an associated processor.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as keyboards or mouses, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Electronic medical records system 104 includes order processing system 114 and physicians work list system 116. Electronic medical records system 104 is configured to store electronic medical record data for patients. In one exemplary embodiment, electronic medical records system 104 can be hosted by an applications service provider, such as using a web-based service that can be accessed by a thin client, web browser or other suitable systems. Electronic medical records system 104 can provide additional practice management functionality, such as to interface with other medical practice systems.

Order processing system 114 is configured to allow a user to enter an order for a medical service from within a patient's electronic medical record. In one exemplary embodiment, the patient's electronic medical record can include one or more user-selectable controls that allow a user to select an order entry screen for one or more medical services, such as by selecting a type of service, a type of test, or other suitable selections. In this exemplary embodiment, the user can select a control and can be presented with one or more lists of available services and tests. Order processing system 114 can generate an order for a selected test or service (such as by generating a Health Level 7 (HL7) ORM standard format message available from Health Level 7 International http://www.hl7.org/), can receive an acknowledgement message in response to the order (such as by receiving an HL7 ACK message) can receive the results for the selected test or service, can store the results or an address of the results in a predetermined location, and can perform other suitable functions. In one exemplary embodiment, order processing system 114 can communicate with other systems and services using HL7 standard format messaging, using proprietary messaging or in other suitable manners.

Physicians work list system 116 is configured to generate a list of work items for a physician. In one exemplary embodiment, physicians work list system 116 can generate one or more user selectable displays and controls that allow a user to view pending work items, completed work items, cancelled work items or other suitable data, and to perform one or more associated functions, such as to request an update.

Health services system 102 includes search by alternate ID system 108, search provider by NPI system 110 and create request system 112. Health services system 102 is configured to provide hosted application services to electronic medical records system 104 over network 118, such as to provide a web-based portal for users of electronic medical records system 104 that can be remotely accessed using web browser, thin client or other suitable systems. Health services system 102 is also configured to interface with one or more insurance services providers 106A through 106N, such as by using industry standard data communications protocols, insurer-specific data formats or other suitable data and processes.

Search by alternate ID system 108 is configured to receive order data from order processing system 114 and to process the order data to identify an alternate ID. In one exemplary embodiment, the order data can be structured and can include a primary ID field that is used for medical records with a practice group and can include one or more alternate IDs that are used to identify a patient with an insurance company or other suitable entities. In this exemplary embodiment, the alternate ID is associated with the patient's electronic medical record and can be an associated field in a database or other suitable data.

Search provider by NPI system 110 is configured to receive the order data and to process the order data to identify a National Provider Identifier (NPI) for one or more service providers, such as a submitting service provider, an ordering service provider, an attending or facility service provider and a servicing service provider.

Create request system 112 is configured to generate a request to an insurance services provider 106A through 106N as a function of the alternate ID from search by alternate ID system 108, the provider NPI data from search provider by NPI system 110 and other suitable data. In one exemplary embodiment, create request system 112 can generate the request based on the data extracted from the order data, can route the request as a function of stored routing data, and perform other suitable functions.

Insurance services providers 106A through 106N are configured to receive request data over network 118 that characterizes requests for approval to obtain health services, tests or other suitable requests to incur expenses for a patient under an insurance plan and to transmit response data to the requesting entity that includes one or more codes that define whether the request was granted and any associated data, such as an authorized cost. In one exemplary embodiment, insurance services providers 106A through 106N can provide data for use by medical services providers, patients or other suitable parties in a standard format, such as an explanation of benefits data message having a predetermined format.

Network 118 can be a public network, a private network, a wire line network, a wireless network, an optical network, other suitable communications media or a suitable combination of such communications media. In one exemplary embodiment, network 118 can be implemented as a virtual private network between electronic medical record system 104 and health services system 102 and as a dedicated communications channel between health services system 102 and each of insurance services providers 106A through 106N.

Medical services provider system 120 is configured to receive an order for a test, service or other suitable procedures from a physician at electronic medical records system 104. In one exemplary embodiment, the HL7 ORM message generated by electronic medical records system 114 or its subsystems can be transmitted to medical services provider system 120, which can be configured to receive and generate HL7 messages, such as to schedule an appointment, to transmit test results back to a referring physician or in other suitable manners.

Insurance services interface system 122 is configured to transmit order messages such as HL7 ORM messages to insurance services provider systems 106A through 106N and to receive response messages such as HL7 responses regarding whether the ordered tests or services have been approved for payment. Insurance services interface system 122 can route the response messages to the associated electronic medical records system 104, such as when health services system 102 is used to provide services to a plurality of electronic medical records systems 104.

In operation, a physician uses electronic medical records system 104 to order a test, a service or other suitable additional procedures using order processing system 114 from within a patient's medical record user interface screen or control, such as while providing medical services to the patient, while reviewing the results of tests or services that were performed by others or in other suitable circumstances. The order data is automatically generated from the data in the patient's electronic medical record, using data that is stored within the electronic medical records system and without the need for separate data entry into an insurance services provider data entry system. The order is then transmitted to health services system 102, which responds with an acknowledgement message that is received and processed by electronic medical records system 104. Electronic medical records system 104 places the order on physician work list 116 as a pending order.

Health services system 102 then processes the order, such as by extracting an alternate ID to identify the associated insurance services provider, by extracting NPI data for any health services providers associated with the order and by formatting a request with data required by the insurance services provider. The order data is then transmitted to the insurance services provider, such as in a batch transmission, a real time transmission or in other suitable manners. After the response to the order is received, health services system 102 generates a message in a format compatible with electronic medical records system 104, such as to update a status on physicians work list system 116.

FIG. 2 is a diagram of an algorithm 200 for seeking approval for medical services from an electronic medical records system in accordance with an exemplary embodiment of the present disclosure. Algorithm 200 can be implemented in hardware or a suitable combination of hardware and software, and can be one or more software systems operating on one or more associated processors.

Algorithm 200 begins at 202 where an order is received from an electronic medical records system in an electronic data format. In one exemplary embodiment, the order can be generated in an HL7 ORM order format or other suitable formats using the Allscripts Electronic Medical Record system, available from Allscripts of Chicago, Ill., or other suitable electronic medical records systems. The electronic medical records system can be hosted as an application service, software as a service or in other suitable manners, and can be accessed using a web browser, a thin client or in other suitable manners. The order can also be transmitted to a third party services provider, medical services provider or other suitable organizations. The algorithm can be implemented as one or more objects having a listen state that listens for a message on a port or in other suitable manners. The algorithm then proceeds to 204.

At 204, an acknowledgement message is transmitted, such as by transmitting an HL7 ACK message from a health services system that provides a hosted electronic medical record service to an electronic medical record system operating on a browser, as a thin client or in other suitable manners. The acknowledgement message can be generated by the object that has the listen state, by an object that is called by another object to process incoming messages, or in other suitable manners. The algorithm then proceeds to 206.

At 206, the order is searched for an alternate ID, such as an ID that is used by an insurance services provider. In addition, a data address for the insurance services provider, message format data for the insurance services provider and other suitable data can also or alternatively be generated, such as by extracting address data or format data stored at a predetermined data address. The algorithm then proceeds to 208.

At 208, the order is searched for provider NPI data, and the associated providers are identified using the NPI data. The provider NPI data can be associated with a submitting service provider who is requesting the services (such as a primary care provider), an ordering service provider who actually orders the service (such as a medical group physician who orders tests where a primary care provider refers a patient to the medical group for tests), an attending (Facility) provider who attends to patient care in an acute care or long-term care setting (such as a physician or surgeon that sees a patient in the hospital or other inpatient or long-term care setting), or a servicing provider who is designated to provide the service. In the example of a primary care provider that refers a patient to a cardiologist, the cardiologist is the servicing provider. In the example of diagnostic laboratory work, the primary care provider would be the submitting provider and would refer the patient to the lab (servicing provider) for a set of lab services, and a physician at the lab would be the ordering provider. In most cases the submitting service provider and ordering service provider are the same. These different service providers can be identified in predetermined delimited fields or in other suitable manners. The algorithm then proceeds to 210.

At 210, a request is generated for authorization of the ordered tests, services or other procedures. In one exemplary embodiment, data is extracted from a patient's electronic medical records and is used to populate a request based on format data for an insurance services provider that is associated with the patient, which is identified from the alternate ID data. The associated provider data is also included with the request, and the request is addressed and transmitted to the insurance services provider at a data address associated with the insurance services provider. The algorithm then proceeds to 212.

At 212, it is determined whether a response has been received to the request. If no response has been received, the algorithm returns to 212, otherwise the algorithm proceeds to 214 where the response is transmitted to an electronic medical records system. In one exemplary embodiment, the electronic medical records system can be hosted by a software as a service provider, such that the response is “transmitted” initially to the system operating in the background and stored, and is subsequently “transmitted” a second time when a user logs onto the electronic medical records system and accesses a patient's electronic medical record, a physician's work list or other user portals to the electronic medical record functionality. The algorithm then proceeds to 216.

At 216, it is determined whether the request has been approved, denied or pended. If it is determined that the request has been approved, the algorithm proceeds to 218 where the request is removed from the doctor's work list. One or more additional processes can also or alternatively be performed, such as to schedule an appointment with the test or service provider. If it is determined that the request has been denied, the algorithm proceeds to 220 where the request is voided, and a suitable entry can be added to the patient's electronic medical record reflecting the denial and the reasons for the denial. Likewise, a suitable HL7 message can be generated to notify the medical services provider or other entity that originally received the HL7 ORM message or other suitable messages that originally ordered the test or service. If it is determined that the request has been pended, the algorithm proceeds to 222 where the status is held, and the process returns to 212.

In operation, algorithm 200 allows a doctor to order tests, services or other procedures from within a patient's electronic medical record and to receive the results of the tests, services or other procedures directly within the patient's electronic medical record. Algorithm 200 thus eliminates the need to separately enter requests for approval for such tests, services or other procedures directly into a system operated by the insurance service provider, and avoids the associated delay and potential for data entry errors.

It should be emphasized that the above-described embodiments are merely examples of possible implementations. Many variations and modifications may be made to the above-described embodiments without departing from the principles of the present disclosure. All, such modifications and variations are intended to be included herein within the scope of this disclosure and protected by the following claims.

What is claimed is:

1. A system for processing medical data comprising:
an order processing system operating on a first processor and configured to receive an order generated from within a patient profile of an electronic medical records system and to generate an order message;
a health services system operating on a second processor and configured to receive the order message and to process the order message to identify an alternate identification field and one or more health services provider fields and to generate an insurance services provider request as a function of the alternate identification field and to transmit the insurance services provider request to an insurance services provider system; and
an insurance services interface system configured to receive a response message from the insurance services provider system and to transmit the response message to the order processing system.

2. The system of claim 1 further comprising the electronic medical records system configured to generate HL7-compliant electronic messages.

3. The system of claim 1 wherein the health services system further comprises a search by alternate identification system configured to receive the order message, to identify a predetermined data field in the order message and to look up format data and address data associated with a data value that is stored in the predetermined data field.

4. The system of claim 1 wherein the health services system further comprises a search provider by national provider identifier system configured to receive the order message, to identify a plurality of predetermined data fields in the order message and to look up national provider identifier data associated with data values that are stored in the plurality of predetermined data fields.

5. The system of claim 1 further comprising a medical services provider system configured to receive the order data and to generate schedule data.

6. A method for processing medical data comprising:
electronically generating a patient account screen user interface from within an electronic medical records system operating on a processor;
electronically generating an order from the patient account screen user interface;
processing the order to identify an insurance services provider;
processing the order to identify a plurality of physicians associated with the order;
electronically generating a physician's work list entry as a function of the order; and
electronically transmitting the order to the identified insurance services provider.

7. The method of claim 6 further comprising electronically receiving a response to the order from the identified insurance services provider.

8. The method of claim 7 further comprising removing the physician's work list entry if the response to order is approved.

9. The method of claim 6 wherein electronically generating the order from the patient account screen user interface comprises electronically generating an HL7 ORM message.

10. The method of claim 9 further comprising electronically receiving an HL7 ACK message in response to the order from the identified insurance services provider.

11. The method of claim 6 wherein processing the order to identify the plurality of physicians associated with the order comprises processing the order to identify a submitting service provider, an ordering service provider, an attending (Facility) provider and a servicing provider.

12. The method of claim 6 wherein electronically generating the physician's work list entry as the function of the order comprises storing a physician's work list entry in a data memory location at a remotely hosted electronic medical records system.

13. The method of claim 6 wherein electronically transmitting the order to the identified insurance services provider comprises storing an insurance services provider patient identifier for the patient in an alternate patent identification field of the electronic medical records system.

14. In a system for processing medical data having an order processing system operating on a first processor and configured to receive an order generated from within a patient profile of an electronic medical records system and to generate an order message, a health services system operating on a second processor and configured to receive the order message and to process the order message to identify an alternate identification field and one or more health services provider fields and to generate an insurance services provider request as a function of the alternate identification field and to transmit the insurance services provider request to an insurance services provider system, an insurance services interface system configured to receive a response message from the insurance services provider system and to transmit the response message to the order processing system, the electronic medical records system configured to generate HL7-compliant electronic messages, wherein the health services system further comprises a search by alternate identification system configured to receive the order message, to identify a predetermined data field in the order message and to look up format data and address data associated with a data value that is stored in the predetermined data field, wherein the health services system further comprises a search provider by national provider identifier system configured to receive the order message, to identify a plurality of predetermined data fields in the order message and to look up national provider identifier data associated with data values that are stored in the plurality of predetermined data fields, further comprising a medical services provider system configured to receive the order data and to generate schedule data, a method for processing medical data comprising:
electronically generating a patient account screen user interface from within an electronic medical records system operating on a third processor;
electronically generating an order from the patient account screen user interface in an HL7 ORM message format;
processing the order to identify an insurance services provider;
processing the order to identify to identify a submitting service provider, an ordering service provider, an attending (Facility) provider and a servicing provider associated with the order;
electronically generating a physician's work list entry as a function of the order;
electronically transmitting the order to the identified insurance services provider by storing an insurance services provider patient identifier for the patient in an alternate patent identification field of the electronic medical records system;
electronically receiving an HL7 ACK message in response to the order from the identified insurance services provider; and
removing the physician's work list entry if the response to order is approved.
